(19) United States
(12) Patent Application Publication
(10) Pub. No.: US 2020/0137217 A1
(43) Pub. Date: Apr. 30, 2020

(54) SMARTPHONE LOCK BOX ASSEMBLY

(71) Applicants: Joseph Buonsante, Farmingdale, NJ (US); Alfonse Cipaldo, Farmingdale, NJ (US)

(72) Inventors: Joseph Buonsante, Farmingdale, NJ (US); Alfonse Cipaldo, Farmingdale, NJ (US)

(21) Appl. No.: 16/176,632

(22) Filed: Oct. 31, 2018

(51) Int. Cl. H04M 1/725; B60K 28/02; H04W 4/48; H04M 1/60

(52) U.S. Cl. CPC H04M 1/72577; B60K 28/02; H04M 1/72569; B60Y 2302/01; H04W 4/48; H04M 1/6091; H04M 1/7253

(57) ABSTRACT

A Smartphone lock box assembly includes a vehicle that has an ignition system and an audio system, and the audio system includes a transceiver. A lock box is positioned within the vehicle and the lock box is in electrical communication with the ignition system. An electronic device is provided that has a transceiver and the electronic device is manipulated to place phone calls and for texting. The electronic device is positionable within the lock box and the lock box is placed in electrical communication with the electronic device when the electronic device is positioned within the lock box. The ignition system is inhibited from being turned on when the transceiver in the vehicle senses the transceiver in the electronic device and the electronic device is not positioned within the box. In this way the electronic device is inhibited from being manipulated for texting while driving.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lock box devices and more particularly pertains to a new lock box device for inhibiting texting while driving.

### BRIEF SUMMARY OF THE INVENTION

An embodiment of the disclosure meets the needs presented above by generally comprising a vehicle that has an ignition system and an audio system, and the audio system includes a transceiver. A lock box is positioned within the vehicle and the lock box is in electrical communication with the ignition system. An electronic device is provided that has a transceiver and the electronic device is manipulated to place phone calls and for texting. The electronic device is positionable within the lock box and the lock box is placed in electrical communication with the electronic device when the electronic device is positioned within the lock box. The ignition system is inhibited from being turned on when the transceiver in the vehicle senses the transceiver in the electronic device and the electronic device is not positioned within the box. In this way the electronic device is inhibited from being manipulated for texting while driving.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an interior view of a Smartphone lock box assembly according to an embodiment of the disclosure.

FIG. 2 is a phantom view of an electronic device positioned in a lock box of an embodiment of the disclosure.

FIG. 3 is a schematic view of an embodiment of the disclosure.

FIG. 4 is a logic tree view of an embodiment of the disclosure.

### DETAILED DESCRIPTION OF THE INVENTION

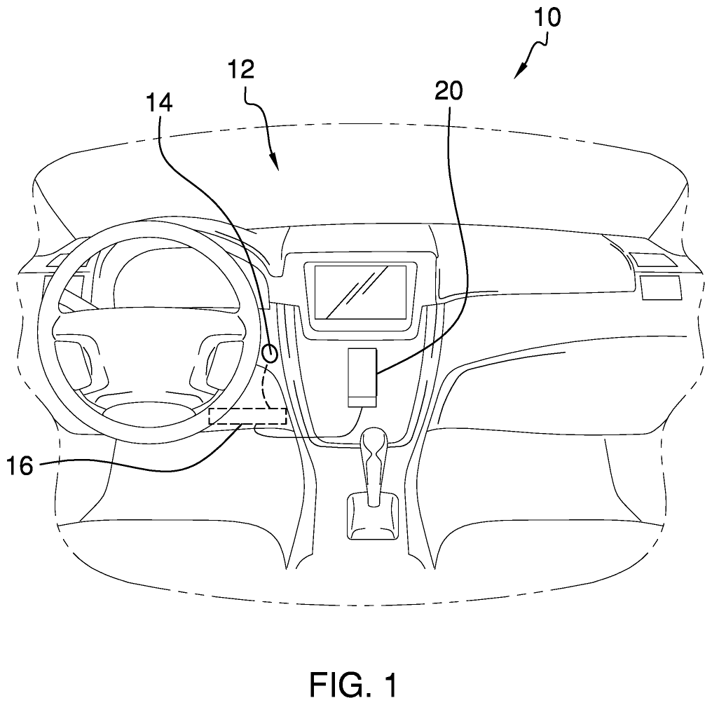

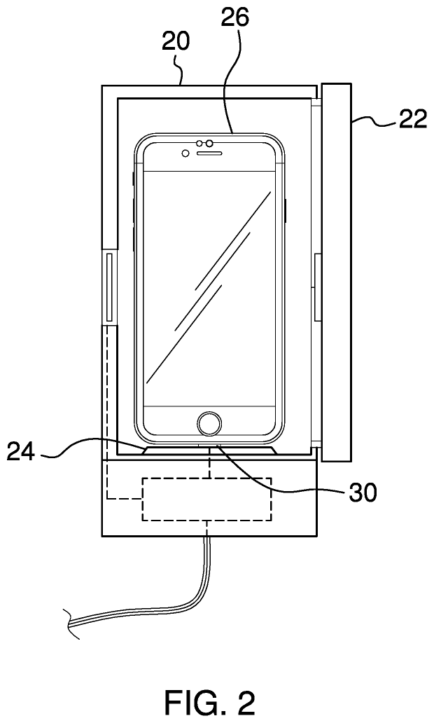

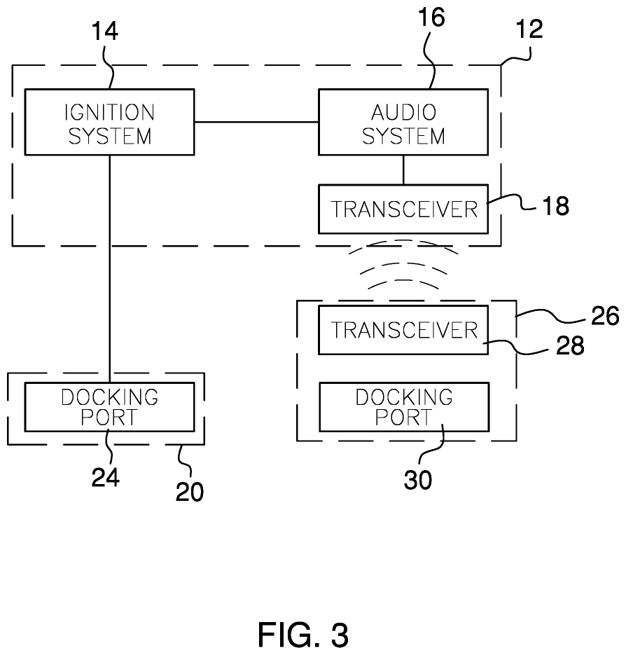

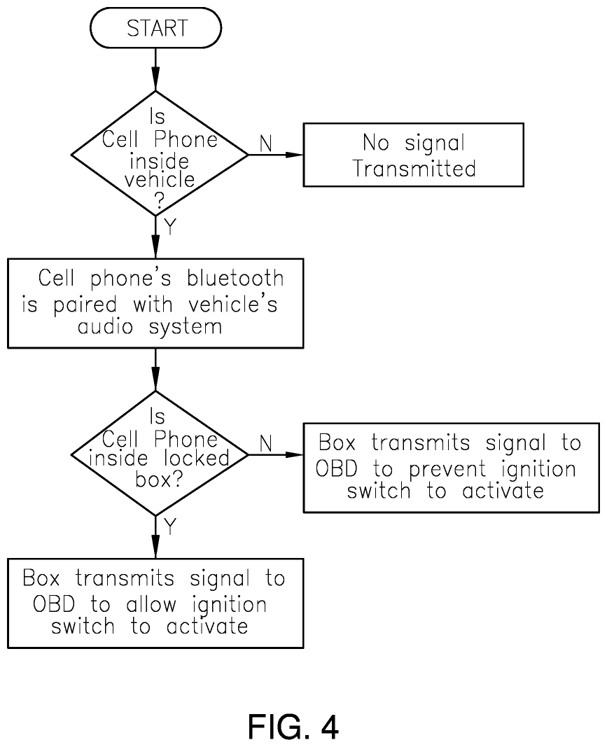

With reference now to the drawings, and in particular to FIGS. 1 through 4 thereof, a new lock box device embodying the principles and concepts of an embodiment of the disclosure and generally designated by the reference numeral 10 will be described.

As best illustrated in FIGS. 1 through 4, the Smartphone lock box assembly 10 generally comprises a vehicle 12 that has an ignition system 14 and an audio system 16, and the audio system 16 includes a transceiver 18. The vehicle 12 may be a passenger vehicle or any other vehicle this is driven on public roadways. Additionally, the transceiver 18 may be a radio frequency transceiver or the like and the transceiver 18 may employ Bluetooth communication protocols. A lock box 20 is positioned within the vehicle 12 and the lock box 20 includes a door 22 that is hingedly coupled thereto for closing the lock box 20. A docking port 24 is coupled to the lock box 20 and the docking port 24 is electrically coupled to the ignition system 14. The docking port 24 may be a usb docking port, a firewire docking port or any other docking port commonly associated with Smartphones.

An electronic device 26 is included that has a transceiver 28 and a docking port 30, and the electronic device 26 is positionable within the lock box 20. The docking port 30 on the electronic device 26 is placed in electrical communication with the docking port 24 on the lock box 20 when the electronic device 26 is positioned within the lock box 20. The electronic device 26 may be a Smartphone and the docking port 30 on the electronic device 26 may be a usb docking port, a firewire docking port or other docking port common to Smartphones. Additionally, the transceiver 28 in the electronic device 26 may be a radio frequency transceiver or the like and the transceiver 28 may employ Bluetooth communication protocols.

The transceiver 28 in the electronic device 26 is in synched with the transceiver 18 in the vehicle 12 when the electronic device 26 is positioned within the vehicle 12. Moreover, the ignition system 14 receives a first input when the transceiver 28 in the electronic device 26 is in electrical communication with the transceiver 18 in the vehicle 12. The ignition system 14 receives a second input when the docking port 30 on the electronic device 26 is in electrical communication with the docking port 24 in the lock box 20. The ignition system 14 is inhibited from being turned on when the ignition system 14 receives the first input but does not receive the second input. In this way the ignition system 14 inhibits the electronic device 26 to be used for texting while driving. The ignition system 14 is permitted to be turned on when the ignition system 14 receives both the first and second inputs. Moreover, any phone calls placed or received on the electronic device 26 are routed through the audio system 16 in the vehicle 12 when the electronic device 26 is positioned in the lock box 20.

In use, the transceiver in the vehicle 12 detects the transceiver 28 in the electronic device 26 when the electronic device 26 is brought into the vehicle 12. Thus, the ignition system 14 receives the first input. The electronic device 26 is placed in the lock box 20 and the docking port 30 on the electronic device 26 is mated to the docking port 24 in the lock box 20. Thus, the ignition system 14 receives the second input. The ignition system 14 cannot be turned on when the ignition system 14 receives only the first input. In this way the vehicle 12 is inhibited from being driven when the electronic device 26 could potentially be used for texting. The ignition system 14 can be turned on when the ignition system 14 receives both the first and second inputs. In this way the vehicle 12 can be drive while the electronic device 26 is not available for texting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A phone lock box assembly being configured to inhibit a phone from being used to text while driving a vehicle, said assembly comprising:
a vehicle having an ignition system and an audio system, said audio system including a transceiver;
a lock box being positioned within said vehicle, said lock box being in electrical communication with said ignition system; and
an electronic device having a transceiver, said electronic device being manipulated to place phone calls and for texting, said electronic device being positionable within said lock box, said lock box being placed in electrical communication with said electronic device when said electronic device is positioned within said lock box, said ignition system being inhibited from being turned on when said transceiver in said vehicle senses said transceiver in said electronic device and said electronic device is not positioned within said box thereby inhibiting said electronic device to be manipulated for texting while driving.

2. The assembly according to claim 1, wherein:
said transceiver in said electronic device is in electrical communication with said transceiver in said vehicle when said electronic device is positioned within said vehicle; and
said ignition system receives a first input when said transceiver in said electronic device is in electrical communication with said transceiver in said vehicle.

3. The assembly according to claim 1, further comprising:
a docking port being coupled to said lock box, said docking port being electrically coupled to said ignition system; and
said electronic device includes a docking port, said docking port on said electronic device being electrically coupled to said docking port on said lock box when said electronic device is positioned within said lock box.

4. The assembly according to claim 3, wherein:
said ignition system receives a first input when said transceiver in said electronic device is in electrical communication with said transceiver in said vehicle; and
said ignition system receives a second input when said docking port on said electronic device is in electrical communication with said docking port in said lock box.

5. The assembly according to claim 4, wherein said ignition system is inhibited from being turned on when said ignition system receives said first input but does not receive said second input wherein said ignition system is configured to inhibit said electronic device to be used for texting.

6. The assembly according to claim 5, wherein said ignition system is permitted to be turned on when said ignition system receives both said first and second inputs.

7. A phone lock box assembly being configured to inhibit a phone from being used to text while driving a vehicle, said assembly comprising:
a vehicle having an ignition system and an audio system, said audio system including a transceiver;
a lock box being positioned within said vehicle, said lock box including a door being hingedly coupled thereto for closing said lock box;
a docking port being coupled to said lock box, said docking port being electrically coupled to said ignition system; and
an electronic device having a transceiver and a docking port, said electronic device being positionable within said lock box, said docking port on said electronic device being placed in electrical communication with said docking port on said lock box when said electronic device is positioned within said lock box, said transceiver in said electronic device being in electrical communication with said transceiver in said vehicle when said electronic device is positioned within said vehicle, said ignition system receiving a first input when said transceiver in said electronic device is in electrical communication with said transceiver in said vehicle, said ignition system receiving a second input when said docking port on said electronic device is in electrical communication with said docking port in said lock box, said ignition system being inhibited from being turned on when said ignition system receives said first input but does not receive said second input wherein said ignition system is configured to inhibit said electronic device to be used for texting, said ignition system being permitted to be turned on when said ignition system receives both said first and second inputs.
